(19) United States
(12) Patent Application Publication
(10) Pub. No.: US 2012/0148715 A1
(43) Pub. Date: Jun. 14, 2012

(54) BERRY DIPPER AND METHOD

(76) Inventor: Alex Dupré, Aliso Viejo, CA (US)

(21) Appl. No.: 12/966,927

(22) Filed: Dec. 13, 2010

(51) Int. Cl. A23P 1/08; A23B 7/015; A23L 1/212

(52) U.S. Cl. 426/302; 99/450.1

(57) ABSTRACT

A dipping system and method for coating of stemmed fruit, includes a conveyer, for transporting stemmed fruit from a loading station to a receiving station, a UV station disposed between the loading and receiving stations, the conveyer running through the UV station for surface microbial disinfection of the stemmed fruit carried by the conveyer. A dipping station is disposed between the UV and receiving stations and includes a heated coating reservoir. Coating of the fruit occurs upon passage of the conveyer over the heated coating reservoir. Fruit holding clips enable suspension of the fruit from the conveyer and enable coating of the fruit without submersion of the conveyer and fruit leaves in the coating reservoir.

The present invention is related to apparatus designed for the preparation of confectionaries and is more particularly directed to the coating, or dipping, of fruits such as strawberries with chocolate.

The coating of strawberries is typically done by hand in which each berry is partially submerged in liquid chocolate. Complete coating of strawberries is inhibited by the strawberry leaves, or leaflets, which usually have oval or serrated leaves in a five petal arrangement.

Such leaves are snuggly abutting the strawberry, which makes full coating difficult. On the other hand, promotion of a good chocolate coat is found by the density of the fruit and seeds, which help keep the chocolate more tight and contained to the berry.

The present invention is directed to a dipping system for coating of stemmed fruit, such as strawberries.

### SUMMARY OF THE INVENTION

In accordance with the present invention, a conveyer may be provided for transporting stemmed fruit from a loading station to a receiving station and a UV station may be disposed between the loading and receiving stations for surface microbial disinfection of the stemmed fruit carried by the conveyer prior to coating.

A dipping station is provided and disposed between the UV and receiving stations and includes a heated coating reservoir. Coating of the fruit occurs upon passage of the conveyer, carrying the fruit, over the heated coating reservoir.

Importantly, fruit holding clips are provided for suspending the fruit from the conveyer and enabling coating of the fruit without submersion of the fruit clips, fruit leaves, or the conveyer in the coating reservoir.

With stemmed fruit, such as strawberries, each holding clip includes a spaced apart upper and lower bracket with the upper bracket having a slot for removably securing a fruit stem proximate an end thereof and the lower bracket having a slot for removably securing the fruit proximate the fruit with leaves disposed atop the lower bracket to prevent coating of the leaves during dipping.

Preferably, the upper and lower brackets are parallel with one another and each have slots at opposing ends thereof. A rod may be provided and attached to the conveyer belt for supporting the upper and lower brackets in the spaced apart arrangement.

A reservoir pulley may be provided for guiding the conveyer toward the reservoir to a point wherein the strawberry fruit is submerged and coated without submerging strawberry leaves or the lower bracket. A depth adjuster is provided and connected to the reservoir pulley for adjusting guidance of the conveyer toward the reservoir in order to adjust an amount of submersion of the strawberries into the coating reservoir.

It follows that a method in accordance with the present invention provides for coating of stemmed fruit by providing a fruit holding clip having an upper bracket with a slot for removably receiving a fruit stem proximate an end thereof and a lower bracket spaced apart from the upper bracket which includes a slot for removably securing the fruit stein proximate the fruit with leaves disposed atop the lower bracket.

The method then further includes inserting the fruit stem proximate one end thereof into the upper bracket slot and inserting the fruit stem proximate the fruit into the lower bracket slot with the fruit leaves disposed atop of the lower bracket and thereafter using the clip to dip the fruit into the coating.

### BRIEF DESCRIPTION OF THE DRAWINGS

The advantages and features of the present invention will be better understood by the following description when considered in conjunction with the accompanying drawings in which:

FIG. 1 is a top view illustration of the system in accordance with the present invention generally showing a loading station, a receiving station, along with a conveyer, UV station, and dipping station;

FIGS. 2 and 3 illustrate end views of the loading and receiving stations;

FIG. 4 is a diagrammatic side view of the system in accordance with the present invention more clearly illustrating movement of the conveyer along with fruit holding clips, which are guided through a coating reservoir;

FIG. 5 is an enlarged view of the fruit holding clips for supporting a stemmed fruit, such as strawberries;

FIG. 6 is a perspective view of the dipping process along with a reservoir pulley and depth adjuster; and

FIG. 7 is an illustration of the fruit clips supporting coated strawberries after dipping.

### DETAILED DESCRIPTION

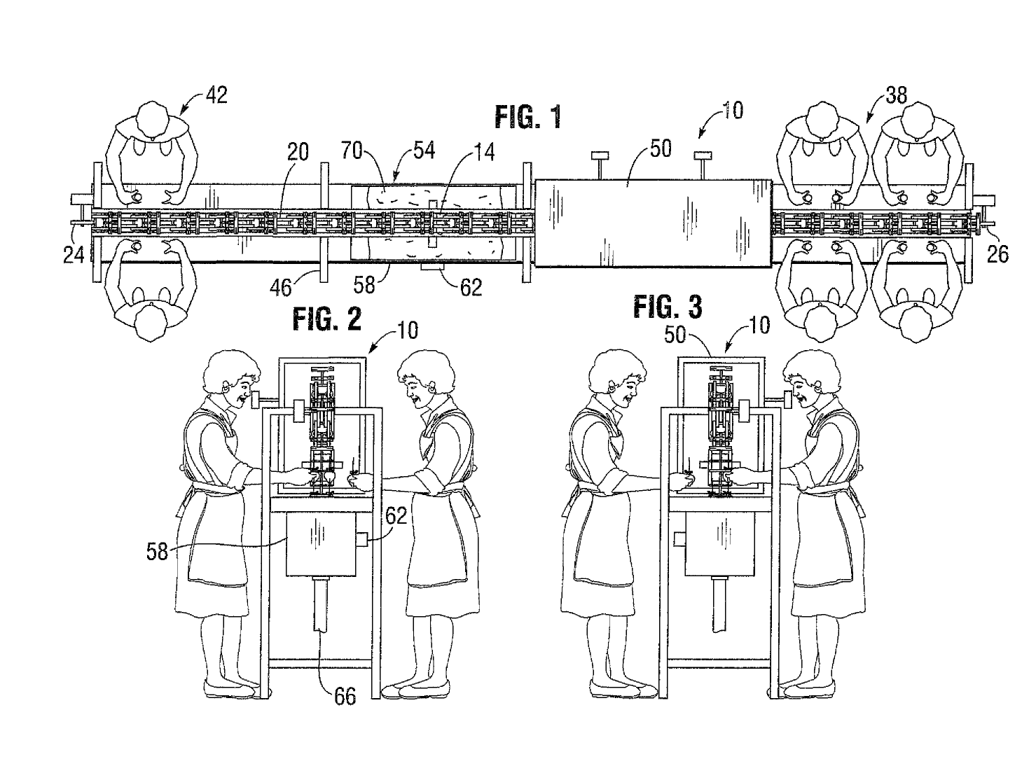

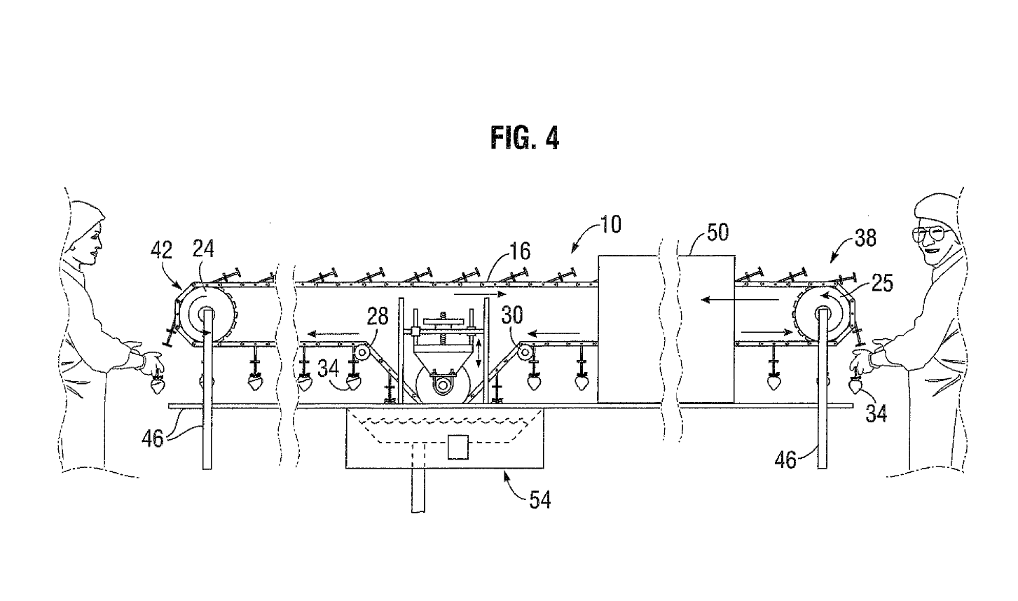

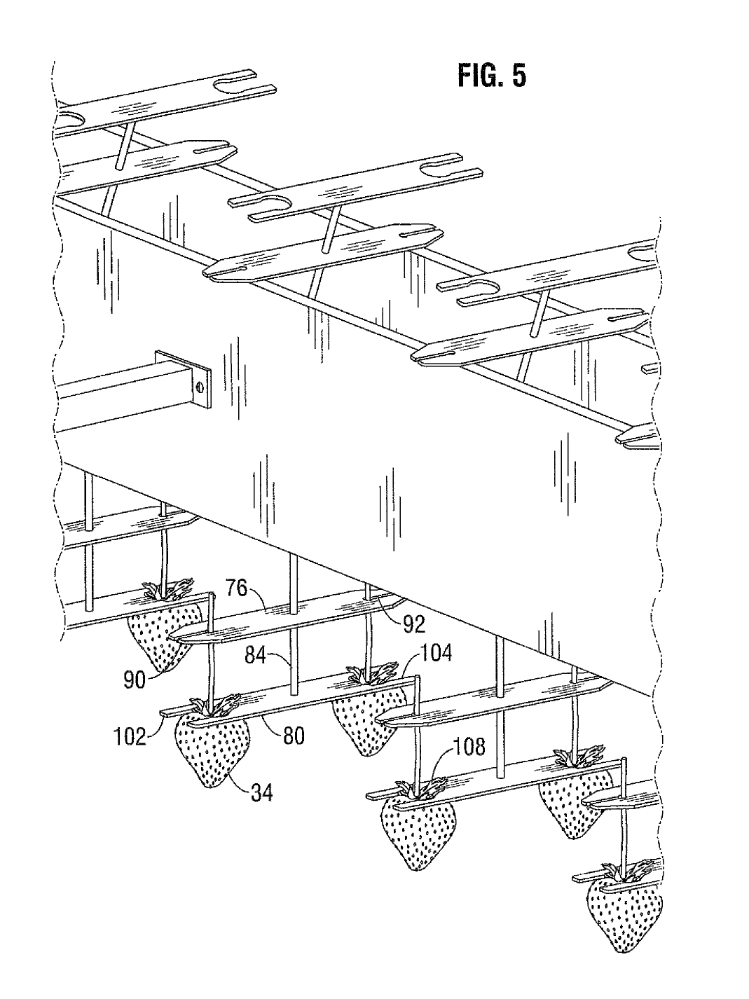

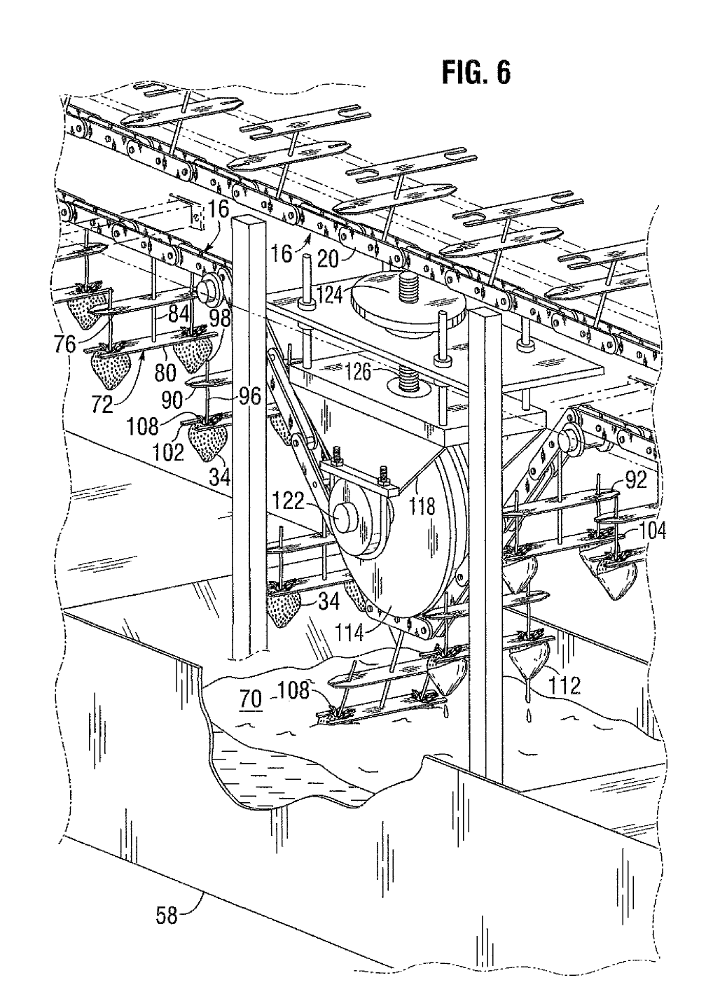

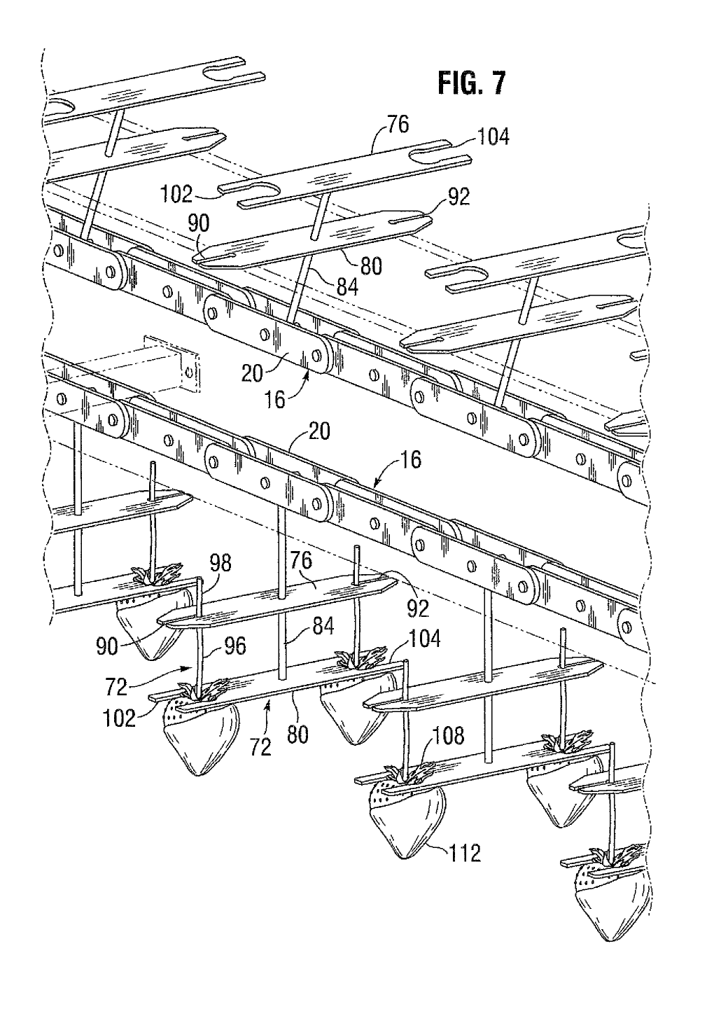

With reference to FIGS. 1-4, there is shown a dipping system 10 in accordance with the present invention for the coating of stemmed fruit, for example, strawberries. A conveyer 16, which may be formed from attached links 20, see also FIGS. 6-7, is supported by tensioned pulleys 24, 26, 28, 30 and provides for transporting the stemmed fruit 34 from a loading station 38 to a receiving station 42. A frame 46 supports all of the components of the system, and all system 10 component may be made from conventional materials.

A UV (ultraviolet) station 50 is disposed on the frame 46 between the loading station 38 and receiving station 42, which includes a conventional UV bulbs for surface microbial disinfection of the fruit 34 carried therethrough by the conveyer 16. A dipping station 54 includes a coating reservoir 58 held to a selected temperature by a heating element 62. The reservoir 58 may be of conventional design with a drain 66 for removal of the coating 70 from the reservoir 58 as needed.

With particular reference to FIGS. 6 and 7, fruit holding clips 72 are provided for suspending the fruit 34 from the conveyer 16 and, as shown in FIG. 6, submerging the fruit 34 in the coating 70 without submersion of the conveyer 16 or the clips 72 in the coating 70.

More specifically, with continued reference to FIGS. 6 and 7, the clips 72 include an upper bracket 76 and a lower bracket 80, which are held in a spaced apart relationship and suspended from the conveyer 16 by a rod 84. Slots 90, 92 in the upper bracket 76 at opposing ends thereof enable removably secure a strawberry stem proximate an end thereof and wider slots 102, 104 provide for removably securing the fruit stein 96 proximate the fruit 34 with leaves 108 atop the lower bracket 80 to prevent coating of the leaves 108 during coating of the fruit 34 as shown in FIG. 6. This clip 72 enables more complete chocolate covering of the fruit 34 without coating the leaves 108 than heretofore possible.

As best shown in FIG. 6, a reservoir pulley is provided for guiding the conveyer 116 toward the reservoir 58 to a point where the fruit 34 is dipped to provide a coated fruit 112 without coating the leaves 108. Minor change in conveyer 16 length due to movement of the reservoir pulley 114 is accommodated by the tensioned pulleys 24, 26, 28, 30.

A depth adjuster 118 connected to a pulley axle 122 is provided for adjusting the guidance of the conveyer 16 toward the reservoir 58 by way of a depth adjuster wheel 124 and screw 126.

Although there has been hereinabove described a specific berry dipper and method in accordance with the present invention for the purpose of illustrating the manner in which the invention may be used to advantage, it should be appreciated that the invention is not limited thereto. That is, the present invention may suitably comprise, consist of or consist essentially of the recited elements. Further, the invention illustratively disclosed herein suitably may be practiced in the absence of any element which is not specifically disclosed herein.

Accordingly, any and all modifications, variations or equivalent arrangements which may occur to those skilled in the art, should be considered to be within the scope of the present invention as defined in the appended claims.

What is claimed is:

1. A dipping system for coating of stemmed fruit, the system comprising:
a conveyer for transporting said stemmed fruit from a loading station to a receiving station;
a UV station disposed between the loading and receiving stations, said conveyer running through said UV station for surface microbial disinfection of said stemmed fruit carried by said conveyer;
a dipping station disposed between the UV and receiving stations and having a heated coating reservoir, coating of the fruit occurring upon passage of said conveyer over said heated coating reservoir; and
fruit holding clips for suspending the fruit from said conveyer and enabling coating of the fruit without submersion of said conveyer in the coating reservoir.

2. The dipping system according to claim 1 wherein the stemmed fruit is a strawberry and each holding clip comprises spaced apart upper and lower brackets, the upper bracket having a slot for removably securing a fruit stem proximate an end thereof and the lower bracket having a slot for removably securing the fruit stem proximate the fruit with leavers disposed atop the lower bracket to prevent coating of the leavers during coating of the fruit.

3. The dipping system according to claim 2 wherein the upper and lower brackets are parallel with one another with each of the upper and lower brackets having slots at opposing ends thereof.

4. The dipping system according to claim 2 wherein said conveyer comprises a tensioned link-belt supported by pulleys.

5. The dipping system according to claim 4 wherein each holding clip comprises a rod attached to the link-belt and supporting the upper and lower brackets in the spaced apart arrangement.

6. The dipping system according to claim 5 first comprises a reservoir pulley for guiding the conveyer toward the reservoir to a point wherein strawberry fruit is submerged and coated without submerging the lower bracket.

7. The dipping system according to claim 6 further comprising a depth adjuster connected to reservoir pulley axles for adjusting guidance of the conveyer toward the reservoir.

8. A dipping system for coating of stemmed fruit, the system comprising:
a fruit holding clip for suspending the fruit, the clip comprising:
an upper bracket having a slot for removably receiving a fruit stem proximate an end thereof; and
a lower bracket, spaced apart from the upper bracket, having a slot for removably securing the fruit stem proximate the fruit with leavers disposed atop the lower bracket.

9. The dipping system according to claim 8 wherein the upper and lower brackets are parallel with one another with each of the upper and lower brackets having slots at opposing ends thereof.

10. A dipping system according to claim 8 further comprising:
a conveyer for transporting said stemmed fruit from a loading station to a receiving station;
a UV station disposed between the loading and receiving stations, said conveyer running through said UV station for surface microbial disinfection of said stemmed fruit carried by said conveyer;
a dipping station disposed between the UV and receiving stations and having a heated coating reservoir, coating of the fruit occurring upon passage of said conveyer over said heated coating reservoir; and
said fruit holding clips are suspended from said conveyer and enable coating of the fruit without submersion of said conveyer in the coating reservoir.

11. The dipping system according to claim 10 wherein said conveyer comprises a tensioned link-belt supported by pulleys.

12. The dipping system according to claim 11 wherein each holding clip comprises a rod attached to the link-belt and supporting the upper and lower bracket in the spaced apart arrangement.

13. The dipping system according to claim 12 first comprises a reservoir pulley for guiding the conveyer toward the reservoir to a point wherein the fruit is submerged and the coating without submerging the lower bracket.

14. The dipping system according to claim 13 further comprising a depth adjuster connected to reservoir pulley axles for adjusting guidance of the conveyer toward the reservoir.

15. A method for coating of stemmed fruit comprises:
providing a fruit holding clip having an upper bracket having a slot for removably receiving a fruit stem proximate an end thereof, and a lower bracket, spaced apart from the upper bracket, having a slot for removably securing the fruit stem proximate the fruit with leavers disposed atop the lower bracket;
inserting the fruit stem proximate end into the upper bracket slot;
inserting the fruit stem proximate the fruit into the lower bracket slot with fruit step disposed atop the lower bracket; and
using the clip to dip the fruit, but not the bracket, into the coating.
